(19) United States
(12) Patent Application Publication
(10) Pub. No.: US 2026/0059553 A1
(43) Pub. Date: Feb. 26, 2026

(54) REFERENCE DURATION DEFINITION AND CONTENTION WINDOW ADJUSTMENT IN SIDELINK-UNLICENSED

(71) Applicant: QUALCOMM Incorporated, San Diego, CA (US)

(72) Inventors: Giovanni CHISCI, San Diego, CA (US); Jing SUN, San Diego, CA (US); Chih-Hao LIU, San Diego, CA (US); Xiaoxia ZHANG, San Diego, CA (US); Stelios STEFANATOS, San Diego, CA (US)

(21) Appl. No.: 19/103,665

(22) PCT Filed: Sep. 14, 2023
(86) PCT No.: PCT/US2023/074187

§ 371 Date: Feb. 13, 2025

(30) Foreign Application Priority Data
Nov. 4, 2022 (GR) 20220100904

(51) Int. Cl. H04W 72/25; H04L 1/1867; H04L 5/00

(52) U.S. Cl. CPC H04W 72/25; H04L 1/1896; H04L 5/0055

(57) ABSTRACT

Aspects relate to defining a reference duration and adjusting a contention window in sidelink-unlicensed (SL-U). In some aspects, the UE may identify a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted. Responsive to identifying the reference duration, the UE may reconfigure a contention window for sidelink communication based on at least one feedback response in response to the at least one reference transmission, and perform a sidelink communication with one or more additional UEs based on the contention window.

### CROSS-REFERENCE TO RELATED APPLICATIONS

The present Application for Patent claims priority to pending Greece Application No. 20220100904, filed Nov. 4, 2022, and assigned to the assignee hereof and hereby expressly incorporated by reference herein as if fully set forth below and for all applicable purposes.

### TECHNICAL FIELD

The technology discussed below relates generally to wireless communication networks, and more particularly, to defining a reference duration and adjusting a contention window in sidelink-unlicensed (SL-U).

### INTRODUCTION

The 5G New Radio (NR) mobile telecommunication systems can provide higher data rates, lower latency, and improved system performance than previous generation systems such as Long Term Evolution (LTE) communication systems. To meet the increasing demand in wireless communications, additional spectrum is needed. However, the amount of licensed spectrum is limited. Therefore, using unlicensed or shared spectrum offers a solution to meet the exponential increase in wireless communication demand. When using an unlicensed carrier, a wireless communication device or a network access node (e.g., a base station) may initiate a channel occupancy time (COT) and utilize a channel access procedure to sense and access the channel prior to any transmission.

Unlicensed spectrum may be utilized for both cellular communications and for sidelink communications. For cellular communications, a cellular network may enable user equipment (UEs) to communicate with one another through signaling with a nearby base station or cell. For sidelink communications, UEs may signal one another directly, rather than via an intermediary base station or cell. In some sidelink network configurations, UEs may further communicate in a cellular network, generally under the control of a base station. Thus, the UEs may be configured for uplink and downlink signaling via a base station and further for sidelink signaling directly between the UEs without transmissions passing through the base station.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a method of wireless communication by a user equipment (UE) is disclosed. The method includes identifying a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted, responsive to identifying the reference duration, reconfiguring a contention window for sidelink communication based on at least one feedback response in response to the at least one reference transmission, and performing a sidelink communication with one or more additional UEs based on the contention window.

In another example, a UE for wireless communication is disclosed. The UE includes at least one processor, a transceiver communicatively coupled to the at least one processor, and a memory communicatively coupled to the at least one processor. The at least one processor may be configured to: identify a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted, responsive to identifying the reference duration, reconfigure a contention window for sidelink communication based on at least one feedback response in response to the at least one reference transmission, and perform a sidelink communication with one or more additional UEs based on the contention window.

In another example, a non-transitory processor-readable storage medium having instructions for UE thereon may be disclosed. The instructions, when executed by a processing circuit, cause the processing circuit to: identify a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted, responsive to identifying the reference duration, reconfigure a contention window for sidelink communication based on at least one feedback response in response to the at least one reference transmission, and perform a sidelink communication with one or more additional UEs based on the contention window

In a further example, a UE for wireless communication may be disclosed. The UE includes means for identifying a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted, means for, responsive to identifying the reference duration, reconfiguring a contention window for sidelink communication based on at least one feedback response in response to the at least one reference transmission, and means for performing a sidelink communication with one or more additional UEs based on the contention window.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is a diagram illustrating an example of a wireless radio access network according to some aspects.

FIG. 2 is a diagram illustrating an example of a frame structure for use in a wireless communication network according to some aspects.

FIG. 3 is a diagram illustrating an example of a wireless communication network employing sidelink communication according to some aspects.

FIG. 4 is a diagram illustrating an example of a Type 1 channel access procedure according to some aspects.

FIGS. 5A and 5B are example diagrams illustrating a definition of a reference duration for a downlink channel access procedure in New Radio-Unlicensed (NR-U), according to some aspects.

FIG. 6A and FIG. 6B are example diagrams illustrating two different types of sidelink communication according to some aspects.

FIG. 7 is an example diagram illustrating identification of a reference duration for a channel access procedure in SL-U and reconfiguration of a contention window, according to some aspects.

FIG. 8 is a block diagram illustrating an example of a hardware implementation for a wireless communication device or a user equipment employing a processing system according to some aspects.

FIG. 9 is a flow chart of an exemplary method for wireless communication in unlicensed spectrum according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes and constitution.

When using an unlicensed carrier (e.g., New Radio - Unlicensed (NR-U) or Sidelink Unlicensed (SL-U)), a wireless communication device (e.g., a user equipment (UE), a scheduled entity, etc.) or a network entity (e.g., a base station, such as a gNode B (gNB), a transmission and reception point (TRP), a scheduling entity, etc.) may initiate a channel occupancy time (COT) of a channel of the unlicensed carrier. The COT is associated with a COT duration in the time domain and available listen-before-talk (LBT) bandwidths in the frequency domain. To initiate the COT, the wireless communication device or the network entity can use a channel access procedure to sense the channel using, for example, energy detection. After performing the channel access procedure, the wireless communication device or network access node can establish the COT to access the channel for an upcoming transmission (e.g., uplink or downlink transmission).

For example, once the wireless communication device or the network entity senses the channel to be idle during a random number of sensing slots, the wireless communication device or the network entity can then establish the COT. The random number of sensing slots may be selected from a set of possible back-off values that may be determined, for example, from a channel access priority class (CAPC) of the data being sent by the wireless communication device or the network entity.

In an NR-U DL procedure, a definition of a reference duration is tied to a unicast communication to transmit a PDSCH. However, in SL-U, a unicast communication as well as other types of communication such as groupcast and broadcast communications may be performed, and a PDSCH is not transmitted. Hence, according to some aspects of the disclosure, a reference duration corresponding to a channel occupancy initiated by a UE including PSSCH transmissions may be defined as a duration starting from the beginning of the channel occupancy until the end of the first slot where at least one reference transmission is transmitted. In some aspects, the UE may identify the reference transmission as either a unicast PSSCH transmission (to a second UE) with HARQ feedback enabled, or a groupcast option 2 PSSCH transmission (to a group of UEs) with HARQ feedback enabled. If the reference duration can be identified, the UE may reconfigure a contention window for sidelink communication based on at least one feedback response in response to the at least one reference transmission, and perform a sidelink communication with one or more additional UEs based on the contention window. If the at least one reference transmission is absent, the reference duration may not be identified, and thus the UE may set the contention window to a most recent contention window used for a sidelink transmission.

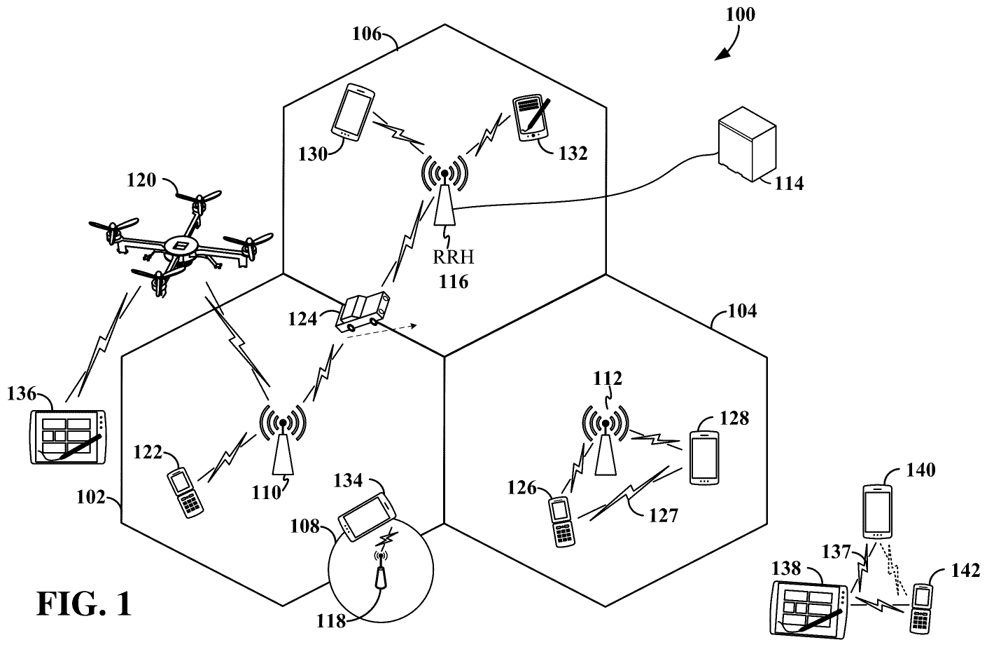

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates cells 102, 104, 106, and cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is a network element in a radio access network responsible for radio transmission and reception in one or more cells to or from a UE. A network entity may also be referred to by those skilled in the art as a base station (BS), base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the TRPs may be an LTE base station, while another TRP may be a 5G NR base station. In some examples, a network entity may be configured in an aggregated or monolithic base station architecture or in a disaggregated base station architecture.

Various network entity (e.g., base station) arrangements can be utilized. For example, in FIG. 1, two base stations 110 and 112 are shown in cells 102 and 104; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the cell 108 which may overlap with one or more macrocells. In this example, the cell 108 may be referred to as a small cell (e.g., a microcell, picocell, femtocell, home base station, home Node B, home eNode B, etc.), as the base station 118 supports a cell having a relatively small size. Cell sizing can be done according to system design as well as component constraints.

It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes an unmanned aerial vehicle (UAV) 120, which may be a drone or quadcopter. The UAV 120 may be configured to function as a base station, or more specifically as a mobile base station. That is, in some examples, a cell may not necessarily be stationary, and the geographic area of the cell may move according to the location of a mobile base station such as the UAV 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station 120. Here, each base station 110, 112, 114, 118, and 120 may be configured to provide an access point to a core network (not shown) for all the UEs in the respective cells. In some examples, the UAV 120 (e.g., the quadcopter) can be a mobile network node and may be configured to function as a UE. For example, the UAV 120 may operate within cell 102 by communicating with base station 110.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (described further below; e.g., UE 122).

For example, DL transmissions may include unicast or broadcast transmissions of control information and/or traffic information (e.g., user data traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz -7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz - 71 GHz), FR4 (52.6 GHz -114.25 GHz), and FR5 (114.25 GHz - 300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). For example, two or more UEs (e.g., UEs 138, 140, and 142) may communicate with each other using sidelink signals 137 without relaying that communication through a base station. In some examples, the UEs 138, 140, and 142 may each function as a scheduling entity or transmitting sidelink device and/or a scheduled entity or a receiving sidelink device to schedule resources and communicate sidelink signals 137 therebetween without relying on scheduling or control information from a base station. In other examples, two or more UEs (e.g., UEs 126 and 128) within the coverage area of a base station (e.g., base station 112) may also communicate sidelink signals 127 over a direct link (sidelink) without conveying that communication through the base station 112. In this example, the base station 112 may allocate resources to the UEs 126 and 128 for the sidelink communication. In either case, such sidelink signaling 127 and 137 may be implemented in a peer-to-peer (P2P) network, a device-to-device (D2D) network, a vehicle-to-vehicle (V2V) network, a vehicle-to-everything (V2X) network, a mesh network, or other suitable direct link network.

In some examples, a D2D relay framework may be included within a cellular network to facilitate relaying of communication to/from the base station 112 via D2D links (e.g., sidelinks 127 or 137). For example, one or more UEs (e.g., UE 128) within the coverage area of the base station 112 may operate as relaying UEs to extend the coverage of the base station 112, improve the transmission reliability to one or more UEs (e.g., UE 126), and/or to allow the base station to recover from a failed UE link due to, for example, blockage or fading.

Two primary technologies that may be used by V2X networks include dedicated short range communication (DSRC) based on IEEE 802.11p standards and cellular V2X based on LTE and/or 5G (New Radio) standards. Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

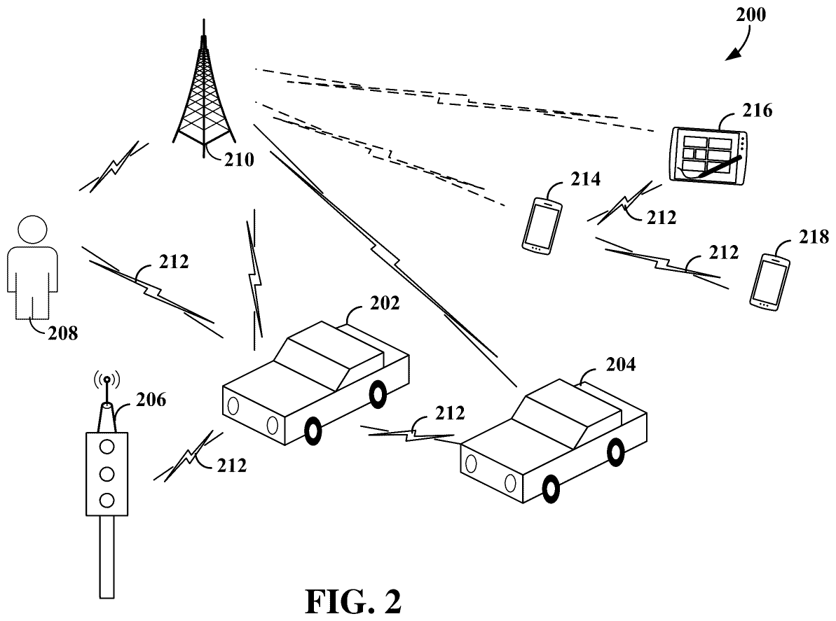

FIG. 2 illustrates an example of a wireless communication network 200 configured to support sidelink communication. In some examples, sidelink communication may include V2X communication. V2X communication involves the wireless exchange of information directly between not only vehicles (e.g., vehicles 202 and 204) themselves, but also directly between vehicles 202/204 and infrastructure (e.g., roadside units (RSUs) 206), such as streetlights, buildings, traffic cameras, tollbooths or other stationary objects, vehicles 202/204 and pedestrians 208, and vehicles 202/204 and wireless communication networks (e.g., network entity 210). The network entity 210 may be, for example, any base station (e.g., gNB, eNB) or other scheduling entity as illustrated in FIG. 1. The network entity 210 may further be implemented in an aggregated or monolithic base station architecture, or in a disaggregated base station architecture. In addition, the network entity 210 may be a stationary network entity or a mobile network entity. In some examples, V2X communication may be implemented in accordance with the New Radio (NR) cellular V2X standard defined by 3GPP, Release 16, or other suitable standard.

V2X communication enables vehicles 202 and 204 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 202 and 204 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian/cyclist 208 may be utilized to trigger a warning sound, vibration, flashing light, etc., in case of imminent danger.

The sidelink communication between vehicle-UEs (V-UEs) 202 and 204 or between a V-UE 202 or 204 and either an RSU 206 or a pedestrian-UE (P-UE) 208 may occur over a sidelink 212 utilizing a proximity service (ProSe) PC5 interface. In various aspects of the disclosure, the PC5 interface may further be utilized to support D2D sidelink 212 communication in other proximity use cases. Examples of other proximity use cases may include public safety or commercial (e.g., entertainment, education, office, medical, and/or interactive) based proximity services. In the example shown in FIG. 2, ProSe communication may further occur between UEs 214, 216, and 218.

ProSe communication may support different operational scenarios, such as in-coverage, out-of-coverage, and partial coverage. Out-of-coverage refers to a scenario in which UEs are outside of the coverage area of a network entity (e.g., network entity 210), but each are still configured for ProSe communication. Partial coverage refers to a scenario in which some of the UEs are outside of the coverage area of the network entity 210, while other UEs are in communication with the network entity 210. In-coverage refers to a scenario in which UEs are in communication with the network entity 210 (e.g., gNB) via a Uu (e.g., cellular interface) connection to receive ProSe service authorization and provisioning information to support ProSe operations.

In some examples, a UE (e.g., UE 218) may not have a Uu connection with the network entity 210. In this example, a D2D relay link (over sidelink 212) may be established between UE 218 and UE 214 to relay communication between the UE 218 and the network entity 210. The relay link may utilize decode and forward (DF) relaying, amplify and forward (AF) relaying, or compress and forward (CF) relaying. For DF relaying, HARQ feedback may be provided from the receiving device to the transmitting device. The sidelink communication over the relay link may be carried, for example, in a licensed frequency domain using radio resources operating according to a 5G NR or NR sidelink (SL) specification and/or in an unlicensed frequency domain, using radio resources operating according to 5G new radio-unlicensed (NR-U) specifications. NR-U operates in the 5 GHz and 6 GHz frequency bands and supports both standalone and licensed-assisted operation based on carrier aggregation and dual connectivity with either NR or LTE in the licensed spectrum. The relay link between UE 214 and UE 218 may be established due to, for example, distance or signal blocking between the network entity 210 and the UE 218, weak receiving capability of the UE 218, low transmission power of the UE 218, limited battery capacity of the UE 218, and/or to improve link diversity. Thus, the relay link may enable communication between the network entity 210 and UE 218 to be relayed via one or more relay UEs (e.g., UE 214) over a Uu wireless communication link and relay link(s) (e.g., between UE 214 and UE 218). In other examples, a relay link may enable sidelink communication to be relayed between a UE (e.g., UE 218) and another UE (e.g., UE 216) over various relay links (e.g., relay links between UEs 214 and 216 and between UEs 214 and 218).

To facilitate D2D sidelink communication between, for example, UEs 214 and 216 over the sidelink 212, the UEs 214 and 216 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 212. For example, the discovery signal may be utilized by the UE 216 to measure the signal strength and channel status of a potential sidelink (e.g., sidelink 212) with another UE (e.g., UE 214). The UE 216 may utilize the measurement results to select a UE (e.g., UE 214) for sidelink communication or relay communication.

In some examples, a common carrier may be shared between the sidelinks 212 and Uu links, such that resources on the common carrier may be allocated for both sidelink communication between UEs (e.g., UEs 202, 204, 206, 208, 214, 216, and 218) and cellular communication (e.g., uplink and downlink communication) between the UEs (e.g., UEs 202, 204, 206, 208, 214, 216, and 218) and the network entity 210. In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. The number of sub-channels in a resource pool may include between one and twenty-seven sub-channels. A radio resource control (RRC) configuration of the resource pools may be either pre-configured (e.g., a factory setting on the UE determined, for example, by sidelink standards or specifications) or configured by a network entity (e.g., network entity 210).

In addition, there may be two main resource allocation modes of operation for sidelink (e.g., PC5) communications. In a first mode, Mode 1, a network entity (e.g., gNB) 210 may allocate resources to sidelink devices (e.g., V2X devices or other sidelink devices) for sidelink communication between the sidelink devices in various manners. For example, the network entity 210 may allocate sidelink resources dynamically (e.g., a dynamic grant) to sidelink devices, in response to requests for sidelink resources from the sidelink devices. For example, the network entity 210 may schedule the sidelink communication via DCI 3_0. In some examples, the network entity 210 may schedule the PSCCH/PSSCH within uplink resources indicated in DCI 3_0. The network entity 210 may further activate preconfigured sidelink grants (e.g., configured grants) for sidelink communication among the sidelink devices. In some examples, the network entity 210 may activate a configured grant (CG) via RRC signaling. In Mode 1, sidelink feedback may be reported back to the network entity 210 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1may include information for resource allocation of a sidelink resource and for decoding of the second stage of sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may be transmitted within the PSSCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

In some examples, the SCI (e.g., SCI-1 and/or SCI-2) may further include a resource assignment of retransmission resources reserved for one or more retransmissions of the sidelink transmission (e.g., the sidelink traffic/data). Thus, the SCI may include a respective PSSCH resource reservation and assignment for one or more retransmissions of the PSSCH. For example, the SCI may include a reservation message indicating the PSSCH resource reservation for the initial sidelink transmission (initial PSSCH) and one or more additional PSSCH resource reservations for one or more retransmissions of the PSSCH.

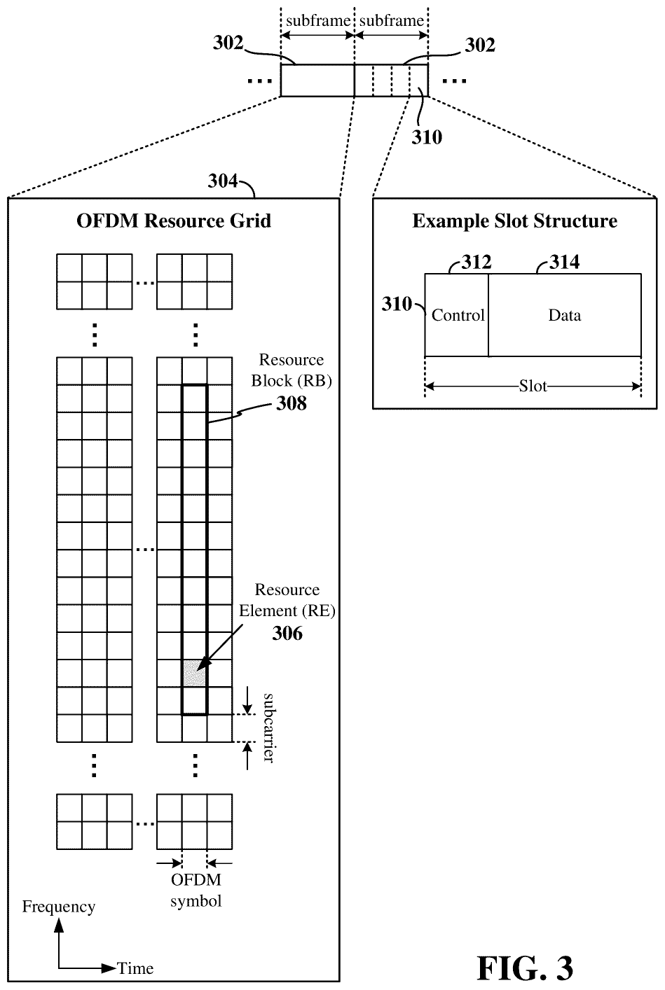

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 13 subcarriers, a number independent of the numerology used. In some examples, depending on the numerology, an RB may include any suitable number of consecutive OFDM symbols in the time domain.

A set of continuous or discontinuous resource blocks may be referred to herein as a Resource Block Group (RBG), sub-band, or bandwidth part (BWP). A set of sub-bands or BWPs may span the entire bandwidth. Scheduling of wireless communication devices (e.g., V2X devices, sidelink devices, or other UEs, hereinafter generally referred to as UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity (e.g., gNB, eNB, etc.) or may be self-scheduled by a UE/sidelink device implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 13 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

Expanded views of slots 310 and 320 each illustrates that the slot 310 includes a control region 312 and a data region 314. In general, the control region 312 may carry control channels, and the data region 314 may carry data channels. In some examples, a Uu slot (e.g., slot 310) may contain all DL, all UL, or at least one DL portion and at least one UL portion. The structures illustrated in FIG. 3 are merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, a slot 310 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a network entity) may allocate one or more REs 306 (e.g., within the control region 312) of the Uu slot 310 to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 306 (e.g., in the control region 312 or the data region 314) of the Uu slot 310 to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 30, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information.

In an UL transmission, the scheduled entity (e.g., UE) may utilize one or more REs 306 of the Uu slot 310 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, a measurement report (e.g., a Layer 1 (L1) measurement report), or any other suitable UCI.

In addition to control information, one or more REs 306 (e.g., within the data region 314) of the Uu slot 310 may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB3 and above.

In an example of sidelink communication over a sidelink carrier via a PC5 interface, the control region 312 of the sidelink slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, sidelink MAC-CEs may be transmitted in the data region 314 of the slot 310. In addition, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

In some examples, a contiguous set of resource blocks (e.g., RBs 308) may be used to form a channel between a network entity and a UE or between UEs (e.g., for sidelink communication). A New Radio - Unlicensed (NR-U) network can use a channel access procedure to enable wireless devices (e.g., network entities and UEs) to access a channel within a shared/unlicensed spectrum. For example, NR-U may allow for up to 400 MHz and 100 MHz of channel bandwidth in the DL and UL, respectively. An example of a channel access procedure for NR-U is a procedure based on channel sensing that evaluates the availability (e.g., idle or busy) of a channel for performing transmissions. The basic unit for sensing is a sensing slot (e.g., 9 μs slot) with a predetermined duration. In one example, a wireless device (e.g., network entity or UE) can detect the energy of signals transmitted by other devices (e.g., via a received signal strength indication (RSSI)) for a predetermined interval (e.g., 4 μs) within a sensing slot. The sensing slot is considered to be idle when the sensed energy is less than a certain energy detection (ED) threshold; otherwise, the sensing slot is considered to be busy (i.e., not available).

After performing a channel access procedure for an NR-U, a wireless device (e.g., network entity or UE) may establish a channel occupancy time (COT), which refers to the total time for which the wireless device and at least one other device sharing the COT can perform transmission(s) on the channel. In one example, a network entity and a UE can share a COT for UL and DL transmissions between the network entity and the UE. As another example, two or more UEs may share a COT for sidelink transmissions therebetween.

Two types of channel access procedures for NR-U are available (e.g., Type 1 and Type 2). Each type of channel access procedure utilizes a different listen-before-talk (LBT) procedure. LBT procedures may involve sensing energy on the channel and comparing the energy to an energy detection (ED) threshold. For example, if the detected energy on the channel is at or below the ED threshold level (e.g., indicating that the channel is relatively free of traffic), the wireless device can gain access to the channel for a transmission. For NR-U, there are four LBT categories defined for channel access. Category 1 (Cat1) LBT specifies that LBT is not used. Category 2 (Cat2) LBT specifies the use of LBT without random back-off. Category 3 (Cat3) LBT specifies the use of LBT with random back-off with a fixed size contention window. Category 4 (Cat4) LBT specifies the use of LBT with random back-off with a variable sized contention window.

In a Type 1 channel access procedure, a wireless device (e.g., network entity or UE) performs a Cat4 LBT, in which the channel access procedure is performed in a time duration spanned by a random number of sensing slots (corresponding to a random back-off) to locate an idle channel before transmission. In a Type 2 channel access procedure, a wireless device (e.g., network entity or UE) performs a Cat1 LBT or Cat2 LBT, in which the channel access procedure is performed in a time duration spanned by a deterministic number of sensing slots to determine an available (e.g., idle) channel before transmission.

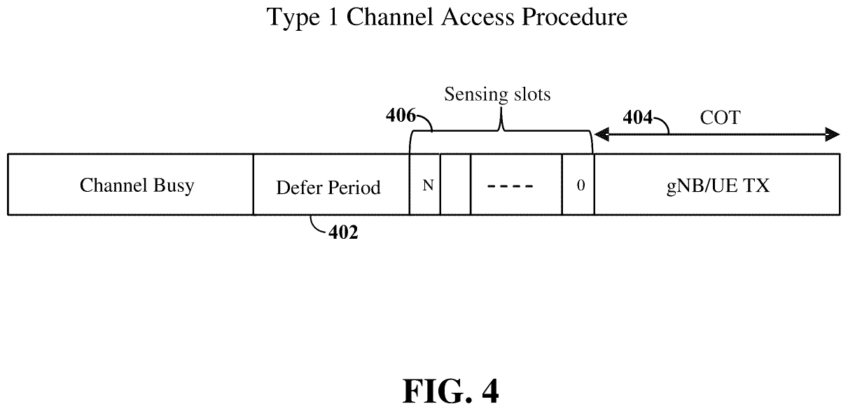

FIG. 4 is a diagram illustrating an example of a Type 1 channel access procedure. After a defer period 402 following a busy channel, a wireless device may transmit (e.g., an UL or DL transmission burst) in a COT 404 after first sensing the channel to be idle during a random number of sensing slots 406 in a defer duration. Thus, Cat4 LBT is used to initiate the COT for DL/UL transmissions within DL/UL transmission bursts. For back-to-back transmissions within a burst, Cat1 LBT may be used. The random number of sensing slots 406 may be selected from a set of possible back-off values (e.g., values within a variable sized contention window). In some examples, the random number of sensing slots 406 may be based on a channel access priority class (CAPC) of the wireless device.

The Type 1 channel access procedure provides a UE with a COT, which allows the UE to transmit up to a maximum channel occupancy time (MCOT) duration. A contention window may be adjusted in the Type 1 channel access procedure.

The reference duration for a DL channel access procedure in NR-U is defined as follows. The reference duration corresponding to a channel occupancy initiated by the gNB including transmission of PDSCH(s) may be defined as a duration starting from the beginning of the channel occupancy until the end of the first slot where at least one unicast PDSCH is transmitted over all the resources allocated for the PDSCH, or until the end of the first transmission burst by the gNB that contains unicast PDSCH(s) transmitted over all the resources allocated for the PDSCH, whichever occurs earlier. If the channel occupancy includes a unicast PDSCH, but it does not include any unicast PDSCH transmitted over all the resources allocated for that PDSCH, then, the duration of the first transmission burst by the gNB within the channel occupancy that contains unicast PDSCH(s) may be the reference duration for contention window adjustment.

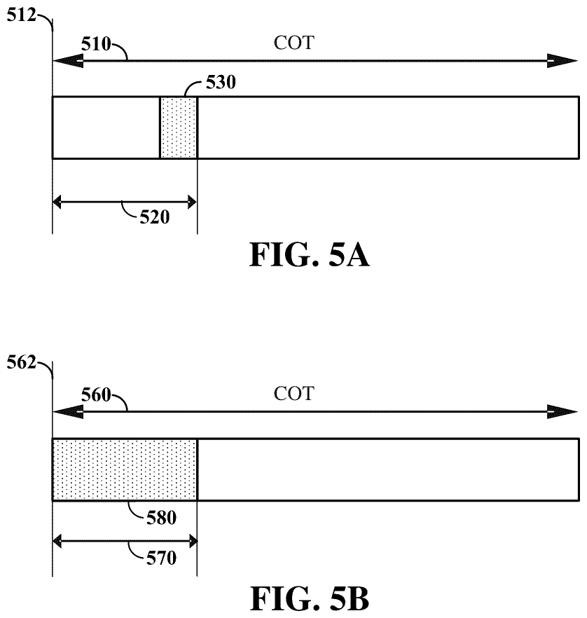

FIGS. 5A and 5B are example diagrams illustrating the definition of the reference duration for a DL channel access procedure in NR-U, according to some aspects. In FIG. 5A, a COT 510 begins at 512 and a reference duration 520 is defined as a duration starting from the beginning of the channel occupancy at 512 until the end of a first slot 530 where at least one unicast PDSCH is transmitted over all the resources allocated for the PDSCH. In FIG. 5B, a COT 560 begins at 562 and a reference duration 570 is defined as a duration starting from the beginning of the channel occupancy at 562 until the end of the first transmission burst 580 by a gNB that contains unicast PDSCH(s) transmitted over all the resources allocated for the PDSCH.

In an NR-U DL procedure, a definition of a reference duration is tied to one type of communication, which is a unicast communication to transmit a PDSCH. On the other hand, sidelink-Unlicensed (SL-U) may allow various types of communication including a unicast communication (HARQ feedback enabled/disabled), a connection-based groupcast communication (HARQ feedback enabled/disabled), a connection-less groupcast communication (HARQ feedback enabled disabled), and a broadcast communication. Further, there is no PDSCH in the SL-U. Despite these differences between the NR-U and the SL-U, a reference duration for the SL-U has not been defined to account for multiple types of communication.

According to some aspects of the disclosure, a reference duration corresponding to a channel occupancy initiated by a UE including PSSCH transmissions may be defined as a duration starting from the beginning of the channel occupancy until the end of the first slot where at least one reference transmission is transmitted. Hence, the UE may identify the reference duration corresponding to the channel occupancy initiated by the UE including PSSCH transmissions based on the at least one reference transmission.

In some aspects, the UE may identify/define the reference transmission as either a unicast PSSCH transmission (to a second UE) with HARQ feedback enabled, or a groupcast option 2 PSSCH transmission (to a group of UEs) with HARQ feedback enabled. In some aspects, the UE may identify/define the reference transmission as the unicast PSSCH transmission with HARQ feedback enabled if at least the unicast PSSCH transmission with HARQ feedback enabled is present, while the reference transmission may be identified/defined as the groupcast option 2 PSSCH transmission with HARQ feedback enabled if the unicast PSSCH transmission with HARQ feedback enabled is absent. For example, in this aspect, the UE finds a slot with a unicast PSSCH transmission with HARQ feedback enabled, the UE may identify/define the reference transmission as the unicast PSSCH transmission with HARQ feedback enabled, regardless of whether the UE finds a slot with a groupcast option 2 PSSCH transmission with HARQ feedback enabled. In this example, if the UE does not find a slot with a unicast PSSCH transmission with HARQ feedback enabled but finds a slot with a groupcast option 2 PSSCH transmission with HARQ feedback enabled, the UE may identify/define the reference transmission as the groupcast option 2 PSSCH transmission with HARQ feedback enabled.

When the UE identifies the reference duration, the UE may reconfigure a contention window for SL communication based on at least one feedback response in response to the at least one reference transmission, and then may perform a SL communication with other UEs based on the contention window. For example, the UE may perform the SL communication based on the contention window by performing a channel access procedure with LBT based on the contention window for performing the sidelink communication. For example, the UE may utilize the contention window to implement a uniform random counter to perform a Type 1 channel access (e.g., Cat 4 LBT).

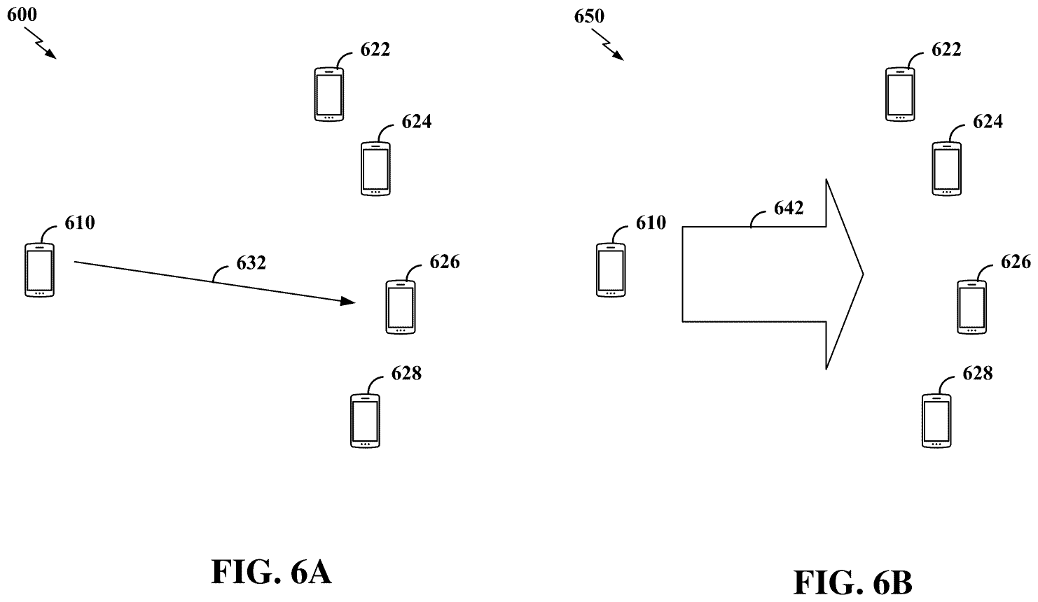

FIG. 6A and FIG. 6B are example diagrams illustrating two different types of sidelink communication according to some aspects. FIG. 6A is an example diagram 600 illustrating a UE transmitting a unicast transmission to a second UE of a group of UEs, according to some aspects. As shown in FIG. 6A, a first UE 610 transmits a PSSCH via a unicast transmission to a second UE 626 of a group of UEs 622, 624, 626, 628. If the HARQ feedback is enabled, in response to the PSSCH transmission, the second UE 626 may transmit, and the first UE 610 may receive, a HARQ feedback, which may include an ACK or a NACK. FIG. 6B is an example diagram 650 illustrating the UE transmitting a groupcast transmission to the group of UEs, according to some aspects. As shown in FIG. 6B, the first UE 610 transmits a PSSCH via a group transmission to the group of UEs 622, 624, 626, 628. If the HARQ feedback is enabled, in response to the PSSCH transmission, each of the UEs 622, 624, 626, 628 may transmit, and the first UE 610 may receive, a respective HARQ feedback, which may include an ACK or a NACK. In some cases, the first UE 610 may fail to receive a HARQ feedback from one or more of the UEs 622, 624, 626, 628. In some aspects, one of the unicast transmission and the groupcast transmission may occur within a reference duration. In another aspect, the unicast transmission and the groupcast transmission may occur within the same reference duration. Based on the HARQ feedback in response to the unicast transmission and/or the multiple HARQ feedbacks in response to the groupcast transmission, the first UE 610 may reconfigure a contention window for SL communication.

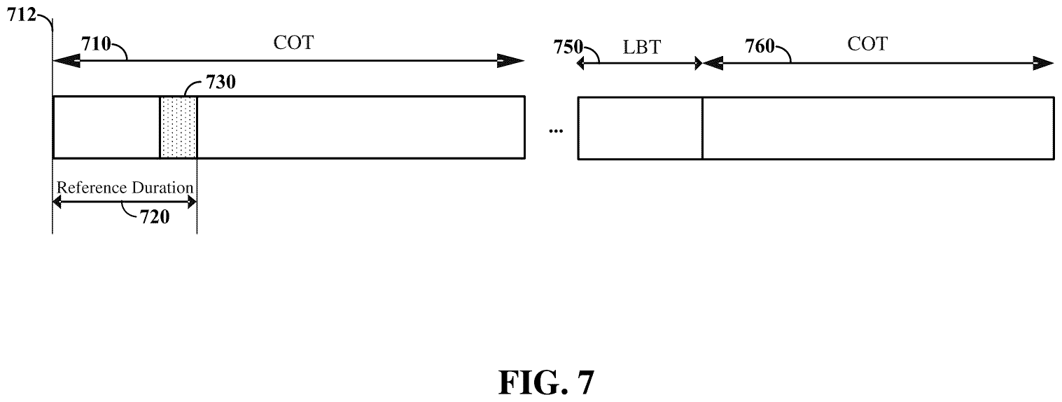

FIG. 7 is an example diagram illustrating identification of a reference duration for a channel access procedure in SL-U and reconfiguration of a contention window, according to some aspects. FIG. 7, a COT 710 begins at 712 and a reference duration 720 is defined/identified as a duration starting from the beginning of the channel occupancy at 712 until the end of a first slot 730 where at least one reference transmission is transmitted. The reference transmission is explained in more detail above. After identifying the reference duration 720, the UE may reconfigure a contention window for SL communication based on at least one feedback response in response to the at least one reference transmission. The UE may use the contention window as a parameter to draw a random number that is used as a counter for the Type 1 access procedure (Cat4 LBT). After performing an LBT procedure at 750, the UE may perform a channel occupancy procedure with LBT based on the contention window and during the COT 760 and perform SL communication.

In some aspects, when the UE reconfigures the contention window for SL communication, the UE may receive a first HARQ feedback from the second UE in response to the unicast PSSCH transmission and/or may receive multiple second HARQ feedbacks from the group of UEs in response to the groupcast option 2 PSSCH transmission. Subsequently, the UE may reconfigure the contention window based on the first HARQ feedback and/or the multiple second HARQ feedbacks.

In some aspects, in an example where the UE receives the first HARQ feedback in response to the unicast PSSCH transmission, if at least one acknowledgement (ACK) is received as the first HARQ feedback, the UE may reset the contention window to a minimum contention window. If no ACK is received as the first HARQ feedback, the UE may increase the contention window.

In some aspects, in an example where the UE receives the multiple second HARQ feedbacks in response to the groupcast PSSCH transmission, either option 1 or option 2 may be used to reconfigure the contention window. According to option 1, based on a ratio associated with one or more ACKs received from one or more UEs of the group of UEs, the UE may reconfigure the contention window. For example, if a ratio of HARQ feedbacks with ACKs to HARQ feedbacks without ACKs exceeds a ratio threshold, then the UE may reset the contention window to a minimum contention window. Otherwise, the UE may increase the contention window. According to option 2, if at least one ACK is received in response to the groupcast PSSCH transmission, then the UE may reset the contention window to a minimum contention window. In option 2, if no ACK is received in response to the groupcast PSSCH transmission, then the UE may increase the contention window.

Hence, in some aspects, when reconfiguring the contention window, the UE may reset the contention window to a minimum contention window if the first HARQ feedback indicates an ACK and/or if the multiple second HARQ feedbacks satisfy a groupcast reset condition. On the other hand, when reconfiguring the contention window, the UE may increase the contention window if the first HARQ feedback indicates a NACK and/or if the multiple second HARQ feedbacks fails to satisfy the groupcast reset condition. Two different options for the groupcast reset condition may exist. According to the first option, the groupcast reset condition may be the multiple second HARQ feedbacks including at least one ACK. According to the second option, the groupcast reset condition may be a ratio associated with a number of ACKs received in the multiple second HARQ feedbacks exceeding a feedback ratio threshold, where the ratio associated with the number of ACKs may be either a ratio of the number of received ACKs to a total number of the multiple second HARQ feedbacks or a ratio of the number of received ACKs to a total number of expected HARQ feedbacks from the group of UEs in response to the groupcast option 2 PSSCH transmission to the group of UEs.

In some cases, different types of communications may be transmitted (e.g., concurrently) within the same reference duration. In some cases, both the unicast PSSCH transmission with HARQ feedback enabled and the groupcast option 2 PSSCH transmission with HARQ feedback enabled may be concurrently transmitted (e.g., during the reference duration). These two types of transmissions may result different HARQ feedbacks, thus providing conflicting approaches for reconfiguring the contention window. Hence, various aspects relate to a new approach to reconfigure the contention window when both the unicast PSSCH transmission with HARQ feedback enabled and the groupcast option 2 PSSCH transmission with HARQ feedback enabled are transmitted within the same reference duration.

In some aspects, the unicast PSSCH transmission includes at least one unicast PSSCH transmission with HARQ feedback enabled to at least one second UE and the groupcast PSSCH transmission includes at least one groupcast option 2 PSSCH transmission with HARQ feedback enabled to the plurality of UEs. In this aspect, when the UE reconfigures the contention window, the UE may receive at least one first HARQ feedback from the at least one second UE in response to the at least one unicast PSSCH transmission and/or may receive multiple second HARQ feedbacks from the group of UEs in response to the at least one groupcast option 2 PSSCH transmission, and then may reconfigure the contention window based on the at least one first HARQ feedback and/or the multiple second HARQ feedbacks.

In some aspects, when the at least one reference transmission includes both the at least one unicast PSSCH transmission with HARQ feedback enabled and the at least one groupcast option 2 PSSCH transmission with HARQ feedback enabled, the UE may reconfigure the contention window based on one of the following approaches. According to a first approach, in some aspects, if one or more of the at least one first HARQ feedback indicate the ACK and/or the second HARQ feedbacks satisfy the groupcast reset condition, the UE may reconfigure the contention window by resetting the contention window to a minimum contention window. Otherwise, in some aspects, the UE may increase the contention window. For example, the groupcast reset condition is explained above. According to a second approach, in some aspects, if one or more of the at least one first HARQ feedback indicates the ACK and the multiple second HARQ feedbacks satisfy the groupcast reset condition, the UE may reconfigure the contention window by resetting the contention window to a minimum contention window. Otherwise, in some aspects, the UE may increase the contention window.

According to a third approach, in some aspects, if a ratio associated with a number of ACKs in the at least one first HARQ feedback and the multiple second HARQ feedbacks exceeds a combined feedback ratio threshold, the UE may reconfigure the contention window by resetting the contention window to a minimum contention window. Otherwise, in some aspects, the UE may increase the contention window. Here, the ratio associated with the number of ACKs may be either a ratio of the number of received ACKs to a total number of the at least one first HARQ feedback and the multiple second HARQ feedbacks or a ratio of the number of received ACKs to a total number of expected HARQ feedbacks from the at least one second UE and the group of UEs respectively in response to the at least one unicast PSSCH transmission and the at least one groupcast option 2 PSSCH transmission. According to a fourth approach, in some aspects, if the at least one reference transmission includes the at least one unicast PSSCH transmission with the HARQ feedback enabled, the UE may reconfigure the contention window based on the at least one first HARQ feedback. For example, if at least one ACK is received as the at least one first HARQ feedback, the UE may reset the contention window to a minimum contention window, but otherwise the UE may increase the contention window. Also, according to the fourth approach, in some aspects, if the at least one reference transmission fails to include the at least one unicast PSSCH transmission with the HARQ feedback enabled but includes the at least one groupcast option 2 PSSCH transmission with HARQ feedback enabled, the UE may reconfigure the contention window based on the multiple second HARQ feedbacks. For example, to reconfigure the contention window based on the multiple second HARQ feedbacks, if the second HARQ feedbacks satisfy the groupcast reset condition, the UE may reconfigure the contention window based on the multiple second HARQ feedbacks.

In some aspects, when neither the unicast PSSCH transmission with HARQ feedback enabled nor the groupcast option 2 PSSCH transmission with HARQ feedback enabled is transmitted, the reference duration may not be identified/defined. For example, when the UE does not find any slot with the unicast PSSCH transmission with HARQ feedback enabled or the groupcast option 2 PSSCH transmission with HARQ feedback enabled, the UE may not define/identify any reference duration, regardless of whether other types of transmissions (e.g., unicast with HARQ FB disabled, groupcast option 2 with HARQ FB disabled, groupcast option 1, broadcast) are transmitted.

In some aspects, if the at least one reference transmission is absent, the UE may fail to identify the reference duration. For example, the unicast PSSCH transmission with HARQ feedback enabled and the groupcast option 2 PSSCH transmission with HARQ feedback enabled are absent, the UE may fail to identify the reference duration. In response to failing to identify the reference duration, the UE may set the contention window to a most recent contention window used for a SL transmission. In an aspect, the contention window may be set prior to a type 1 channel access procedure.

For example, if a UE transmits SL transmissions using Type 1 channel access procedures associated with a channel access priority class p on a channel and the SL transmissions are not associated with explicit HARQ-ACK feedbacks by corresponding UE(s), the UE may adjust a contention window for the channel access priority class p (CWₚ) before the Type 1 channel access procedure, using the latest CWₚ used for any SL transmissions on the channel using Type 1 channel access procedures associated with the channel access priority class p. The SL transmissions may not be associated with explicit HARQ-ACK feedbacks by corresponding UE(s) when it is not possible to identify a reference duration in the most recent channel occupancy. For example, when only transmissions without explicit HARQ feedback (i.e., unicast with HARQ feedback disabled, groupcast option 2 with HARQ feedback disabled, groupcast option 1, and broadcast) are performed during the channel occupancy, the UE may not identify the reference duration. In those cases, the UE may not reconfigure the contention window, and thus the contention window may be maintained as a most recent contention window used for a SL transmission.

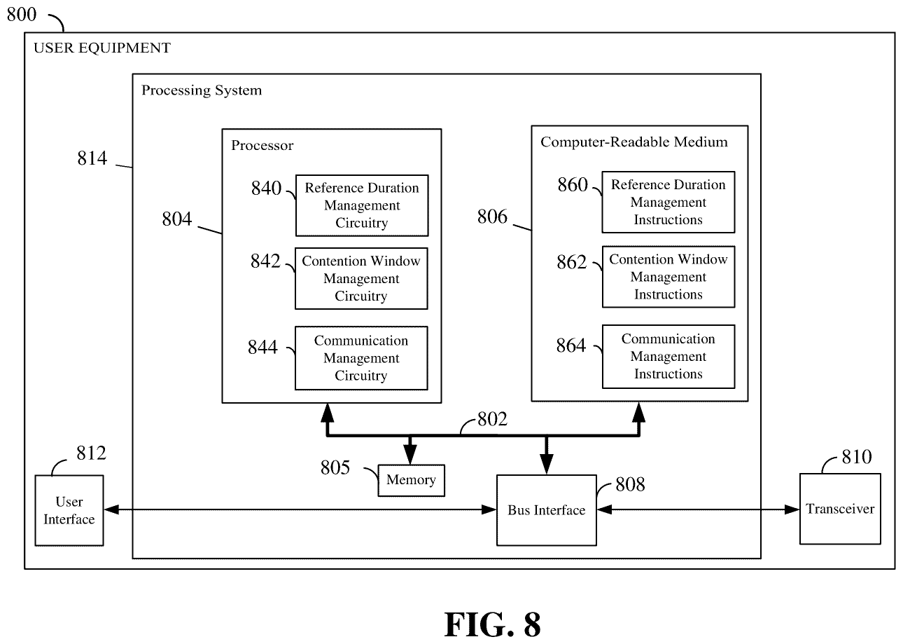

FIG. 8 is a block diagram illustrating an example of a hardware implementation for a wireless communication device or a UE 800 employing a processing system 814. For example, the UE 800 may be a UE as illustrated in any one or more of FIGS. 1, 2, and/or 6.

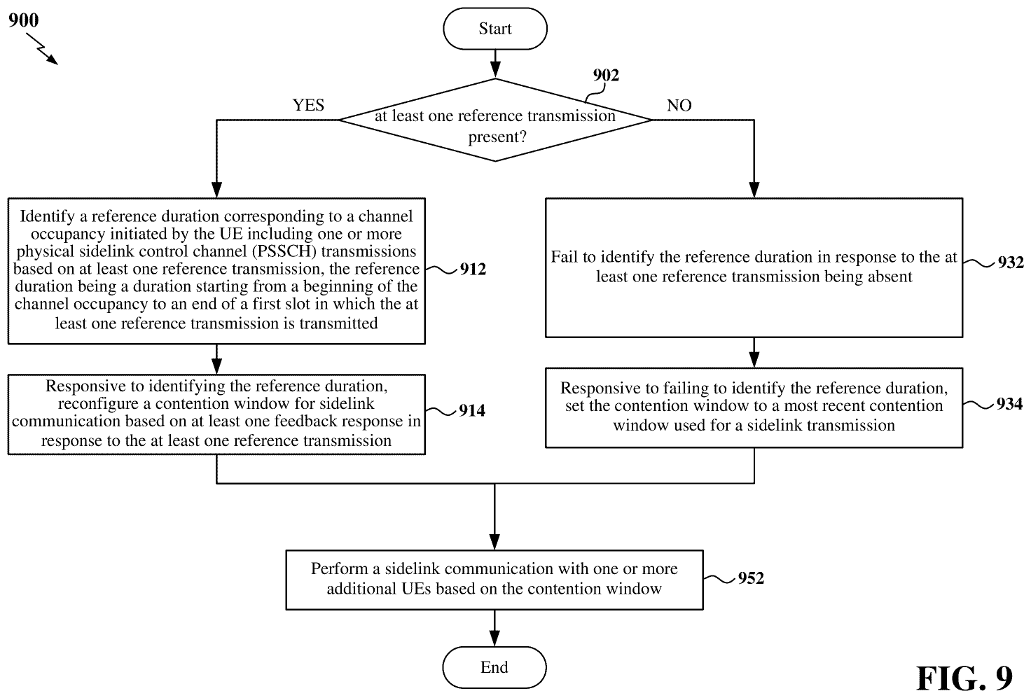

The UE 800 may be implemented with a processing system 814 that includes one or more processors 804. Examples of processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 800 may be configured to perform any one or more of the functions described herein. That is, the processor 804, as utilized in a UE 800, may be used to implement any one or more of the processes and procedures described below and illustrated in FIG. 9.

In this example, the processing system 814 may be implemented with a bus architecture, represented generally by the bus 802. The bus 802 may include any number of interconnecting buses and bridges depending on the specific application of the processing system 814 and the overall design constraints. The bus 802 communicatively couples together various circuits including one or more processors (represented generally by the processor 804), a memory 805, and computer-readable media (represented generally by the computer-readable storage medium 806). The bus 802 may also link various other circuits such as timing sources, peripherals, voltage regulators, and power management circuits, which are well known in the art, and therefore, will not be described any further. A bus interface 808 provides an interface between the bus 802 and a transceiver 810. The transceiver 810 provides a communication interface or means for communicating with various other apparatus over a transmission medium. Depending upon the nature of the apparatus, a user interface 812 (e.g., keypad, display, speaker, microphone, joystick) may also be provided.

In some aspects of the disclosure, the processor 804 may include reference duration management circuitry 840 configured for various functions, including, for example, determining whether at least one reference transmission is present. For example, the reference duration management circuitry 840 may be configured to implement one or more of the functions described below in relation to FIG. 9, including, e.g., block 902.

In some aspects, the reference duration management circuitry 840 may be configured for various functions, including, for example, identifying a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted. For example, the reference duration management circuitry 840 may be configured to implement one or more of the functions described below in relation to FIG. 9, including, e.g., block 912.

In some aspects, the reference duration management circuitry 840 may be configured for various functions, including, for example, failing to identify the reference duration in response to the at least one reference transmission being absent. For example, the reference duration management circuitry 840 may be configured to implement one or more of the functions described below in relation to FIG. 9, including, e.g., block 932.

In some aspects of the disclosure, the processor 804 may include contention window management circuitry 842 configured for various functions, including, for example, responsive to identifying the reference duration, reconfiguring a contention window for sidelink communication based on at least one feedback response in response to the at least one reference transmission. For example, the contention window management circuitry 842 may be configured to implement one or more of the functions described below in relation to FIG. 9, including, e.g., block 914.

In some aspects, the contention window management circuitry 842 may be configured for various functions, including, for example, responsive to failing to identify the reference duration, setting the contention window to a most recent contention window used for a sidelink transmission. For example, the contention window management circuitry 842 may be configured to implement one or more of the functions described below in relation to FIG. 9, including, e.g., block 934.

In some aspects of the disclosure, the processor 804 may include communication management circuitry 844 configured for various functions, including, for example, performing a sidelink communication with one or more additional UEs based on the contention window. For example, the communication management circuitry 844 may be configured to implement one or more of the functions described below in relation to FIG. 9, including, e.g., block 952.

The processor 804 is responsible for managing the bus 802 and general processing, including the execution of software stored on the computer-readable storage medium 806. The software, when executed by the processor 804, causes the processing system 814 to perform the various functions described below for any particular apparatus. The computer-readable storage medium 806 and the memory 805 may also be used for storing data that is manipulated by the processor 804 when executing software.

One or more processors 804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 806. The computer-readable storage medium 806 may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 806 may reside in the processing system 814, external to the processing system 814, or distributed across multiple entities including the processing system 814. The computer-readable storage medium 806 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

In some aspects of the disclosure, the computer-readable storage medium 806 may include reference duration management software/instructions 860 configured for various functions, including, for example, determining whether at least one reference transmission is present. For example, the reference duration management software/instructions 860 may be configured to implement one or more of the functions described below in relation to FIG. 9, including, e.g., block 902.

In some aspects, the reference duration management software/instructions 860 may be configured for various functions, including, for example, identifying a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted. For example, the reference duration management software/instructions 860 may be configured to implement one or more of the functions described below in relation to FIG. 9, including, e.g., block 912.

In some aspects, the reference duration management software/instructions 860 may be configured for various functions, including, for example, failing to identify the reference duration in response to the at least one reference transmission being absent. For example, the reference duration management software/instructions 860 may be configured to implement one or more of the functions described below in relation to FIG. 9, including, e.g., block 932.

In some aspects of the disclosure, the computer-readable storage medium 806 may include contention window management software/instructions 862 configured for various functions, including, for example, responsive to identifying the reference duration, reconfiguring a contention window for sidelink communication based on at least one feedback response in response to the at least one reference transmission. For example, the contention window management software/instructions 862 may be configured to implement one or more of the functions described below in relation to FIG. 9, including, e.g., block 914.

In some aspects, the contention window management software/instructions 862 may be configured for various functions, including, for example, responsive to failing to identify the reference duration, setting the contention window to a most recent contention window used for a sidelink transmission. For example, the contention window management software/instructions 862 may be configured to implement one or more of the functions described below in relation to FIG. 9, including, e.g., block 934.

In some aspects of the disclosure, the computer-readable storage medium 806 may include communication management software/instructions 864 configured for various functions, including, for example, performing a sidelink communication with one or more additional UEs based on the contention window. For example, the communication management software/instructions 864 may be configured to implement one or more of the functions described below in relation to FIG. 9, including, e.g., block 952.

FIG. 9 is a flow chart illustrating an exemplary process 900 for wireless communication in accordance with some aspects of the present disclosure. As described below, some or all illustrated features may be omitted in a particular implementation within the scope of the present disclosure, and some illustrated features may not be required for implementation of all embodiments. In some examples, the process 900 may be carried out by the UE 800 illustrated in FIG. 8. In some examples, the process 900 may be carried out by any suitable apparatus or means for carrying out the functions or algorithm described below.

At block 902, in some aspects, the UE may determine whether at least one reference transmission is present. For example, the reference duration management circuitry 840 shown and described above in connection with FIG. 8 may provide means for determining whether at least one reference transmission is present.

In some aspects, the at least one reference transmission may include at least one of a unicast PSSCH transmission to a second UE with hybrid automatic repeat-request (HARQ) feedback enabled or a groupcast option 2 PSSCH transmission to a plurality of UEs with HARQ feedback enabled.

At block 912, the UE may identify a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted. In some aspects, block 912 may be performed when the at least one reference transmission is present. For example, the reference duration management circuitry 840 shown and described above in connection with FIG. 8 may provide means for identifying the reference duration.

In some aspects, in response to at least the unicast PSSCH transmission with HARQ feedback enabled being present, the at least one reference transmission may include the unicast PSSCH transmission with HARQ feedback enabled, or in response to the unicast PSSCH transmission with HARQ feedback enabled being absent, the at least one reference transmission may include the groupcast option 2 PSSCH transmission with HARQ feedback enabled. In some aspects, the reference duration may not be not identified when neither the unicast PSSCH transmission with HARQ feedback enabled nor the groupcast option 2 PSSCH transmission with HARQ feedback enabled is transmitted.

At block 914, responsive to identifying the reference duration, the UE may reconfigure a contention window for sidelink communication based on at least one feedback response in response to the at least one reference transmission. For example, the contention window management circuitry 842 shown and described above in connection with FIG. 8 may provide means for reconfiguring the contention window.

In some aspects, the reconfiguring the contention window at block 914 may include receiving at least one of a first HARQ feedback from the second UE in response to the unicast PSSCH transmission or a plurality of second HARQ feedbacks from the plurality of UEs in response to the groupcast option 2 PSSCH transmission, and reconfiguring the contention window based on the at least one of the first HARQ feedback or the plurality of second HARQ feedbacks.

In some aspects, the reconfiguring the contention window at block 914 may include resetting the contention window to a minimum contention window responsive to at least one of: the first HARQ feedback indicating an acknowledgement (ACK), or the plurality of second HARQ feedbacks satisfying a groupcast reset condition.

In some aspects, the groupcast reset condition may be either: the plurality of second HARQ feedbacks comprising at least one ACK, or a ratio associated with a number of ACKs received in the plurality of second HARQ feedbacks exceeding a feedback ratio threshold, the ratio being either a ratio of the number of received ACKs to a total number of the plurality of second HARQ feedbacks or a ratio of the number of received ACKs to a total number of expected HARQ feedbacks from the plurality of UEs in response to the groupcast option 2 PSSCH transmission.

In some aspects, the reconfiguring the contention window may include increasing the contention window responsive to at least one of: the first HARQ feedback indicating a negative acknowledgement (NACK), or the plurality of second HARQ feedbacks failing to satisfy the groupcast reset condition.

In some aspects, the unicast PSSCH transmission may include at least one unicast PSSCH transmission with HARQ feedback enabled to at least one second UE and the groupcast PSSCH transmission includes at least one groupcast option 2 PSSCH transmission with HARQ feedback enabled to the plurality of UEs. In this aspect, the reconfiguring the contention window at block 914 may include receiving at least one of at least one first HARQ feedback from the at least one second UE in response to the at least one unicast PSSCH transmission or a plurality of second HARQ feedbacks from the plurality of UEs in response to the at least one groupcast option 2 PSSCH transmission, and reconfiguring the contention window based on at least one of the at least one first HARQ feedback or the plurality of second HARQ feedbacks.

In some aspects, the at least one reference transmission includes the at least one unicast PSSCH transmission with HARQ feedback enabled and the at least one groupcast option 2 PSSCH transmission with HARQ feedback enabled. In this aspect, the reconfiguring the contention window at block 914 may include resetting the contention window to the minimum contention window responsive to one of: at least one of one or more of the at least one first HARQ feedback indicating the ACK or the plurality of second HARQ feedbacks satisfying a groupcast reset condition, one or more of the at least one first HARQ feedback indicating the ACK and the plurality of second HARQ feedbacks satisfying the groupcast reset condition, or a ratio associated with a number of ACKs received in the at least one first HARQ feedback and the plurality of second HARQ feedbacks exceeding a combined feedback ratio threshold, the ratio being either a ratio of the number of received ACKs to a total number of the at least one first HARQ feedback and the plurality of second HARQ feedbacks or a ratio of the number of received ACKs to a total number of expected HARQ feedbacks from the at least one second UE and the plurality of UEs respectively in response to the at least one unicast PSSCH transmission and the at least one groupcast option 2 PSSCH transmission.

In some aspects, the reconfiguring the contention window at block 914 may include reconfiguring the contention window based on the at least one first HARQ feedback in response to the at least one reference transmission including the at least one unicast PSSCH transmission with the HARQ feedback enabled, and wherein the reconfiguring the contention window comprises reconfiguring the contention window based on the plurality of second HARQ feedbacks in response to the at least one reference transmission failing to include the at least one unicast PSSCH transmission with HARQ feedback enabled and including the at least one groupcast option 2 PSSCH transmission with HARQ feedback enabled.

At block 932, the UE may fail to identify the reference duration in response to the at least one reference transmission being absent. For example, the reference duration management circuitry 840 shown and described above in connection with FIG. 8 may provide means for failing to identify the reference duration.

At block 934, responsive to failing to identify the reference duration, the UE may set the contention window to a most recent contention window used for a sidelink transmission. For example, the contention window management circuitry 842 shown and described above in connection with FIG. 8 may provide means for setting the contention window to the most recent contention window. In some aspects, the contention window may be set prior to a type 1 channel access procedure.

At block 952, the UE may perform a sidelink communication with one or more additional UEs based on the contention window. For example, the communication management circuitry 844 shown and described above in connection with FIG. 8 may provide means for performing the sidelink communication based on the contention window. In some aspects, the performing the sidelink communication based on the contention window at block 952 may include performing a channel access procedure with listen before talk (LBT) based on the contention window for performing the sidelink communication.

In one configuration, the UE 800 for wireless communication includes means for identifying a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted, means for, responsive to identifying the reference duration, reconfiguring a contention window for sidelink communication based on at least one feedback response in response to the at least one reference transmission, and means for performing a sidelink communication with one or more additional UEs based on the contention window. In some aspects, the UE 800 may further include means for failing to identify the reference duration in response to the at least one reference transmission being absent, and means for, responsive to failing to identify the reference duration, setting the contention window to a most recent contention window used for a sidelink transmission. In one aspect, the aforementioned means may be the processor(s) 804 shown in FIG. 8 configured to perform the functions recited by the aforementioned means. In another aspect, the aforementioned means may be a circuit or any apparatus configured to perform the functions recited by the aforementioned means.

Of course, in the above examples, the circuitry included in the processor 804 is merely provided as an example, and other means for carrying out the described functions may be included within various aspects of the present disclosure, including but not limited to the instructions stored in the computer-readable storage medium 806, or any other suitable apparatus or means described in any one of the FIGS. 1, 2, and/or 6, and utilizing, for example, the processes and/or algorithms described herein in relation to FIG. 9.

The following provides an overview of several aspects of the present disclosure.

Aspect 1: A method of wireless communication by a user equipment (UE), comprising: identifying a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted; responsive to identifying the reference duration, reconfiguring a contention window for sidelink communication based on at least one feedback response in response to the at least one reference transmission; and performing a sidelink communication with one or more additional UEs based on the contention window.

Aspect 2: The method of aspect 1, wherein the at least one reference transmission comprises: at least one of a unicast PSSCH transmission to a second UE with hybrid automatic repeat-request (HARQ) feedback enabled or a groupcast option 2 PSSCH transmission to a plurality of UEs with HARQ feedback enabled.

Aspect 3: The method of aspect 2, wherein, in response to at least the unicast PSSCH transmission with HARQ feedback enabled being present, the at least one reference transmission comprises the unicast PSSCH transmission with HARQ feedback enabled, or wherein, in response to the unicast PSSCH transmission with HARQ feedback enabled being absent, the at least one reference transmission comprises the groupcast option 2 PSSCH transmission with HARQ feedback enabled.

Aspect 4: The method of aspect 2 or 3, wherein the reference duration is not identified when neither the unicast PSSCH transmission with HARQ feedback enabled nor the groupcast option 2 PSSCH transmission with HARQ feedback enabled is transmitted.

Aspect 5: The method of any of aspects 2 through 4, wherein the reconfiguring the contention window comprises: receiving at least one of a first HARQ feedback from the second UE in response to the unicast PSSCH transmission or a plurality of second HARQ feedbacks from the plurality of UEs in response to the groupcast option 2 PSSCH transmission; and reconfiguring the contention window based on the at least one of the first HARQ feedback or the plurality of second HARQ feedbacks.

Aspect 6: The method of aspect 5, wherein the reconfiguring the contention window comprises resetting the contention window to a minimum contention window responsive to at least one of: the first HARQ feedback indicating an acknowledgement (ACK), or the plurality of second HARQ feedbacks satisfying a groupcast reset condition.

Aspect 7: The method of aspect 6, wherein the groupcast reset condition is either: the plurality of second HARQ feedbacks comprising at least one ACK, or a ratio associated with a number of ACKs received in the plurality of second HARQ feedbacks exceeding a feedback ratio threshold, the ratio being either a ratio of the number of received ACKs to a total number of the plurality of second HARQ feedbacks or a ratio of the number of received ACKs to a total number of expected HARQ feedbacks from the plurality of UEs in response to the groupcast option 2 PSSCH transmission.

Aspect 8: The method of aspect 6 or 7, wherein the reconfiguring the contention window comprises increasing the contention window responsive to at least one of: the first HARQ feedback indicating a negative acknowledgement (NACK), or the plurality of second HARQ feedbacks failing to satisfy the groupcast reset condition.

Aspect 9: The method of aspect 2, wherein the unicast PSSCH transmission includes at least one unicast PSSCH transmission with HARQ feedback enabled to at least one second UE and the groupcast PSSCH transmission includes at least one groupcast option 2 PSSCH transmission with HARQ feedback enabled to the plurality of UEs, and wherein the reconfiguring the contention window comprises: the reconfiguring the contention window comprises; and reconfiguring the contention window based on at least one of the at least one first HARQ feedback or the plurality of second HARQ feedbacks.

Aspect 10: The method of aspect 9, wherein the at least one reference transmission includes the at least one unicast PSSCH transmission with HARQ feedback enabled and the at least one groupcast option 2 PSSCH transmission with HARQ feedback enabled, and wherein the reconfiguring the contention window comprises resetting the contention window to the minimum contention window responsive to one of: at least one of one or more of the at least one first HARQ feedback indicating the ACK or the plurality of second HARQ feedbacks satisfying a groupcast reset condition, one or more of the at least one first HARQ feedback indicating the ACK and the plurality of second HARQ feedbacks satisfying the groupcast reset condition, or a ratio associated with a number of ACKs received in the at least one first HARQ feedback and the plurality of second HARQ feedbacks exceeding a combined feedback ratio threshold, the ratio being either a ratio of the number of received ACKs to a total number of the at least one first HARQ feedback and the plurality of second HARQ feedbacks or a ratio of the number of received ACKs to a total number of expected HARQ feedbacks from the at least one second UE and the plurality of UEs respectively in response to the at least one unicast PSSCH transmission and the at least one groupcast option 2 PSSCH transmission.

Aspect 11: The method of aspect 9, wherein the reconfiguring the contention window comprises reconfiguring the contention window based on the at least one first HARQ feedback in response to the at least one reference transmission including the at least one unicast PSSCH transmission with the HARQ feedback enabled, and wherein the reconfiguring the contention window comprises reconfiguring the contention window based on the plurality of second HARQ feedbacks in response to the at least one reference transmission failing to include the at least one unicast PSSCH transmission with HARQ feedback enabled and including the at least one groupcast option 2 PSSCH transmission with HARQ feedback enabled.

Aspect 12: The method of any of aspects 1 through 11, further comprising: failing to identify the reference duration in response to the at least one reference transmission being absent; and responsive to failing to identify the reference duration, setting the contention window to a most recent contention window used for a sidelink transmission.

Aspect 13: The method of aspect 12, wherein the contention window is set prior to a type 1 channel access procedure.

Aspect 14: The method of any of aspects 1 through 13, wherein the performing the sidelink communication based on the contention window comprises performing a channel access procedure with listen before talk (LBT) based on the contention window for performing the sidelink communication.

Aspect 15: A user equipment (UE) comprising: a transceiver configured to communicate with a radio access network, a memory, and a processor communicatively coupled to the transceiver and the memory, wherein the processor and the memory are configured to perform any one of aspects 1 through 14.

Aspect 16: A UE configured for wireless communication comprising at least one means for performing any one of aspects 1 through 14.

Aspect 17: A non-transitory processor-readable storage medium having instructions for a UE thereon, wherein the instructions, when executed by a processing circuit, cause the processing circuit to perform any one of aspects 1 through 14.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIG. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2 and/or 11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) for wireless communication, comprising:
at least one processor;
a transceiver communicatively coupled to the at least one processor; and a memory communicatively coupled to the at least one processor,
wherein the at least one processor is configured to:
identify a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted;
responsive to identifying the reference duration, reconfigure a contention window for sidelink communication based on at least one feedback response in response to the at least one reference transmission; and
perform a sidelink communication with one or more additional UEs based on the contention window.

2. The UE of claim 1, wherein the at least one reference transmission comprises:
at least one of a unicast PSSCH transmission to a second UE with hybrid automatic repeat-request (HARQ) feedback enabled or a groupcast option 2 PSSCH transmission to a plurality of UEs with HARQ feedback enabled.

3. The UE of claim 2, wherein, in response to at least the unicast PSSCH transmission with HARQ feedback enabled being present, the at least one reference transmission comprises the unicast PSSCH transmission with HARQ feedback enabled, or wherein, in response to the unicast PSSCH transmission with HARQ feedback enabled being absent, the at least one reference transmission comprises the groupcast option 2 PSSCH transmission with HARQ feedback enabled.

4. The UE of claim 2, wherein the reference duration is not identified when neither the unicast PSSCH transmission with HARQ feedback enabled nor the groupcast option 2 PSSCH transmission with HARQ feedback enabled is transmitted.

5. The UE of claim 2, wherein the at least one processor configured to reconfigure the contention window is configured to:
receive at least one of a first HARQ feedback from the second UE in response to the unicast PSSCH transmission or a plurality of second HARQ feedbacks from the plurality of UEs in response to the groupcast option 2 PSSCH transmission; and reconfigure the contention window based on the at least one of the first HARQ feedback or the plurality of second HARQ feedbacks.

6. The UE of claim 5, wherein the at least one processor configured to reconfigure the contention window is configured to reset the contention window to a minimum contention window responsive to at least one of:
the first HARQ feedback indicating an acknowledgement (ACK), or the plurality of second HARQ feedbacks satisfying a groupcast reset condition.

7.-8. (canceled)

9. The UE of claim 2, wherein the unicast PSSCH transmission includes at least one unicast PSSCH transmission with HARQ feedback enabled to at least one second UE and the groupcast PSSCH transmission includes at least one groupcast option 2 PSSCH transmission with HARQ feedback enabled to the plurality of UEs, and wherein the at least one processor configured to reconfigure the contention window is configured to:
receive at least one of at least one first HARQ feedback from the at least one second UE in response to the at least one unicast PSSCH transmission or a plurality of second HARQ feedbacks from the plurality of UEs in response to the at least one groupcast option 2 PSSCH transmission; and
reconfigure the contention window based on at least one of the at least one first HARQ feedback or the plurality of second HARQ feedbacks.

10.-11. (canceled)

12. The UE of claim 1, wherein the at least one processor is further configured to:
fail to identify the reference duration in response to the at least one reference transmission being absent; and
responsive to failing to identify the reference duration, set the contention window to a most recent contention window used for a sidelink transmission.

13. (canceled)

14. The UE of claim 1, wherein the at least one processor configured to perform the sidelink communication based on the contention window is configured to perform a channel access procedure with listen before talk (LBT) based on the contention window for performing the sidelink communication.

15. A method of wireless communication by a user equipment (UE), comprising:
identifying a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted;
responsive to identifying the reference duration, reconfiguring a contention window for sidelink communication based on at least one feedback response in response to the at least one reference transmission; and
performing a sidelink communication with one or more additional UEs based on the contention window.

16. The method of claim 15, wherein the at least one reference transmission comprises:
at least one of a unicast PSSCH transmission to a second UE with hybrid automatic repeat-request (HARQ) feedback enabled or a groupcast option 2 PSSCH transmission to a plurality of UEs with HARQ feedback enabled.

17. The method of claim 16, wherein, in response to at least the unicast PSSCH transmission with HARQ feedback enabled being present, the at least one reference transmission comprises the unicast PSSCH transmission with HARQ feedback enabled, or
wherein, in response to the unicast PSSCH transmission with HARQ feedback enabled being absent, the at least one reference transmission comprises the groupcast option 2 PSSCH transmission with HARQ feedback enabled.

18. The method of claim 16, wherein the reference duration is not identified when neither the unicast PSSCH transmission with HARQ feedback enabled nor the groupcast option 2 PSSCH transmission with HARQ feedback enabled is transmitted.

19. The method of claim 16, wherein the reconfiguring the contention window comprises:
receiving at least one of a first HARQ feedback from the second UE in response to the unicast PSSCH transmission or a plurality of second HARQ feedbacks from the plurality of UEs in response to the groupcast option 2 PSSCH transmission; and reconfiguring the contention window based on the at least one of the first HARQ feedback or the plurality of second HARQ feedbacks.

20. The method of claim 19, wherein the reconfiguring the contention window comprises resetting the contention window to a minimum contention window responsive to at least one of:
the first HARQ feedback indicating an acknowledgement (ACK), or the plurality of second HARQ feedbacks satisfying a groupcast reset condition.

21.-22. (canceled)

23. The method of claim 16, wherein the unicast PSSCH transmission includes at least one unicast PSSCH transmission with HARQ feedback enabled to at least one second UE and the groupcast option 2 PSSCH transmission includes at least one groupcast option 2 PSSCH transmission with HARQ feedback enabled to the plurality of UEs, and
wherein the reconfiguring the contention window comprises:
receiving at least one of at least one first HARQ feedback from the at least one second UE in response to the at least one unicast PSSCH transmission or a plurality of second HARQ feedbacks from the plurality of UEs in response to the at least one groupcast option 2 PSSCH transmission; and
reconfiguring the contention window based on at least one of the at least one first HARQ feedback or the plurality of second HARQ feedbacks.

24.-25. (canceled)

26. The method of claim 15, further comprising:
failing to identify the reference duration in response to the at least one reference transmission being absent; and
responsive to failing to identify the reference duration, setting the contention window to a most recent contention window used for a sidelink transmission.

27. A non-transitory processor-readable storage medium having instructions for a user equipment (UE) thereon, wherein the instructions, when executed by a processing circuit, cause the processing circuit to:
identify a reference duration corresponding to a channel occupancy initiated by the UE including one or more physical sidelink control channel (PSSCH) transmissions based on at least one reference transmission, the reference duration being a duration starting from a beginning of the channel occupancy to an end of a first slot in which the at least one reference transmission is transmitted;
responsive to identifying the reference duration, reconfigure a contention window for sidelink communication based on at least one feedback response in response to the at least one reference transmission; and
perform a sidelink communication with one or more additional UEs based on the contention window.

28. The non-transitory processor-readable storage medium of claim 27, wherein the at least one reference transmission comprises:
at least one of a unicast PSSCH transmission to a second UE with hybrid automatic repeat-request (HARQ) feedback enabled or a groupcast option 2 PSSCH transmission to a plurality of UEs with HARQ feedback enabled.

29. The non-transitory processor-readable storage medium of claim 27, wherein the instructions, when executed by a processing circuit, further cause the processing circuit to:
fail to identify the reference duration in response to the at least one reference transmission being absent; and
responsive to failing to identify the reference duration, set the contention window to a most recent contention window used for a sidelink transmission.

30. (canceled)
